(19) United States
(12) Patent Application Publication
(10) Pub. No.: US 2010/0018476 A1
(43) Pub. Date: Jan. 28, 2010

(54) On-board hydrogen generator

(76) Inventors: Svetlana Mikhailovna Zemskova, Edelstein, IL (US); Herbert Florey Martins DaCosta, Peoria, IL (US); Mark Jay Andrews, Edelstein, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/806,378

(22) Filed: May 31, 2007

(51) Int. Cl. F02B 43/08; F01N 3/10; F01N 3/01

(52) U.S. Cl. 123/3; 60/299; 60/275

(57) ABSTRACT

A hydrogen generator for use with an engine is disclosed. The hydrogen generator has an exhaust duct situated to receive exhaust from the engine, and an SCR device located within the exhaust duct. The hydrogen generator also has a housing in fluid communication with the exhaust duct upstream of the SCR device, an electrolyte solution disposed within the housing, and a plurality of electrodes at least partially submerged in the electrolyte solution. The electrodes are electrically powered to produce hydrogen gas, and the hydrogen gas is directed to mix with the exhaust.

### TECHNICAL FIELD

The present disclosure relates generally to a hydrogen generator, and more particularly, to a hydrogen generator located on-board a mobile vehicle.

### BACKGROUND

Various technologies have been implemented by engine manufacturers to meet diesel engine emission requirements mandated by the Environmental Protection Agency (EPA). Selective Catalytic Reduction (SCR) is one common technology used to control emission of NOₓ from diesel engines. The basic principle of SCR is the reduction of NOₓ to N₂ and H₂O by a reductant in the presence of a catalyst. In typical automotive SCR systems, a gaseous or liquid reductant (most commonly ammonia or urea) is added to the exhaust gas stream of the engine. The reductant reduces the NOₓ from the exhaust in a catalytic converter at high temperatures. The catalytic converter typically contains a catalyst that will trigger the reducing reaction at the desired temperature. Various catalyst media, such as metal containing zeolite or metal containing catalyst coated on an alumina porous carrier media, have been used with automotive SCRs. The particular metal catalyst and the carrier media are typically selected based on the exhaust gas temperature.

There is considerable discussion among engine manufacturers about the relative merits of different reductants used to reduce NOₓ. Specifically, while ammonia generally offers good NOₓ reduction, it is toxic and difficult to handle safely. Urea, on the other hand, is safer to handle but not quite as effective. In both cases, the reductant must be pure, to prevent impurities from clogging an inlet surface of the catalyst. A major issue with urea reductants is the lack of distribution infrastructure available to support this technology for automotive uses. For this reason, the EPA has been reluctant to certify diesel engines fitted with an SCR system employing ammonia or urea catalyst.

To alleviate the necessity of supplying the reductant from external sources, NOₓ reduction technologies employing in-situ reductant production have been proposed. These technologies use various combinations of fuel (or other hydrocarbon additives), air and water to produce an H₂/CO reductant mixture on-board the vehicle for NOₓ removal. One such exhaust NOₓ reduction technique using a reductant produced on-board a vehicle is described in U.S. Pat. No. 7,163,668 B2 (the '668 patent) issued to Bartley et al. on Jan. 16, 2007. In the NOₓ reduction approach described in the '668 patent, diesel fuel is partially oxidized to produce a reductant mixture of hydrogen (H₂) and carbon monoxide (CO) with traces of carbon dioxide (CO₂) and water (H₂O). The mixture is then passed into the exhaust gas stream of an engine. The exhaust, along with the reductant mixture, is then passed through a hydrogen SCR(H—SCR), where the H₂ in the mixture reduces the NOₓ to nitrogen and water.

Although the NOₓ reduction technique of the '668 patent may alleviate the need to supply the reductant from external sources, the described approach may have some drawbacks. A common problem with such reductant systems is CO and hydrocarbon “slip.” Slip describes exhaust pipe emissions of CO and hydrocarbon that occur when exhaust gas temperature is too cold for the SCR reaction to occur, and/or when the injection device feeds too much reductant into the exhaust gas stream for the amount of NOₓ present. In the NOₓ reduction technique of the '668 patent, in addition to the CO tail pipe emissions that result from diesel fuel oxidation, incomplete oxidation of the diesel fuel may also cause hydrocarbon tail pipe emissions to increase. Using diesel fuel to generate the hydrogen gas may also increase the fuel consumption, and, thus the operating costs, of the engine.

The present disclosure is directed at overcoming one or more of the shortcomings set forth above.

### SUMMARY OF THE INVENTION

In one aspect, a hydrogen generator for use with an engine is disclosed. The hydrogen generator includes an exhaust duct situated to receive exhaust from the engine, and an SCR device located within the exhaust duct. The hydrogen generator also includes a housing in fluid communication with the exhaust duct upstream of the SCR device, an electrolyte solution disposed within the housing, and a plurality of electrodes at least partially submerged in the electrolyte solution. The electrodes are electrically powered to produce hydrogen gas, and the hydrogen gas is directed to mix with the exhaust.

In another aspect, a method of reducing NOₓ contained in exhaust gas of an engine is disclosed. The method includes passing electric current through electrodes immersed in an electrolyte to produce hydrogen gas, and mixing the hydrogen gas with an exhaust flow from the engine. The method further includes catalyzing the hydrogen/exhaust gas mixture to reduce the NOₓ in the exhaust gas.

In yet another aspect, a machine is disclosed. The machine includes an engine configured to combust fuel/air mixture to produce exhaust gas containing NOₓ, a fuel delivery system configured to direct fuel into the engine, and a battery configured to crank engine. The machine also includes a housing containing a supply of electrolyte, and a plurality of electrodes at least partially submerged in the electrolyte. The electrodes are powered by the battery to produce hydrogen gas. The machine also includes an SCR device, which receives a mixture of the hydrogen gas and the exhaust gas, and reduces at least a portion of the NOₓ to nitrogen and water.

### BRIEF DESCRIPTION OF THE DRAWINGS

FIG. 1 is a schematic illustration of an exemplary disclosed engine system;

FIG. 2 is a diagrammatic illustration of an exemplary disclosed hydrogen generator for use with the engine of FIG. 1; and

FIG. 3A and FIG. 3B are exemplary embodiments of an exemplary disclosed electrode for use with the hydrogen generator of FIG. 2.

### DETAILED DESCRIPTION

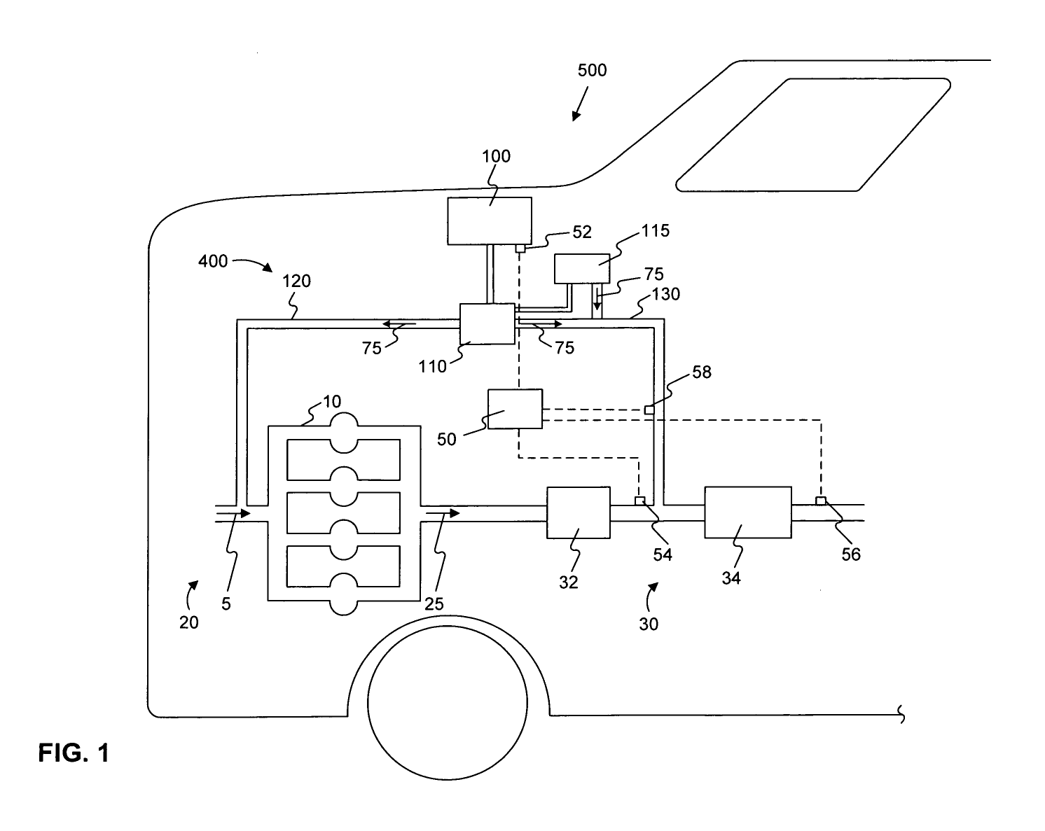

FIG. 1 illustrates a machine 500 having an engine system 400. The machine 500 may be a mobile or stationary machine. Non-limiting examples of the machine 500 include automobiles, trains, generators, construction equipment, etc. The engine system 400 may include various systems and components that cooperate to convert chemical energy contained in a fuel to mechanical work. Engine system 400 may include, among others, a power source 10, a fuel/air input system 20, an exhaust system 30, and a hydrogen generator 100. Power source 10 may be coupled between fuel/air input system 20 and exhaust system 30. Fuel/air input system 20 may input a fuel 5 and air into the power source 10 for combustion. Exhaust system 30 may remove exhaust gases 25 produced by the combustion process from power source 10.

Power source 10 may include an internal combustion engine such as, for example, a diesel engine, a gasoline engine, a natural gas engine, or any other engine apparent to one skilled in the art. During operation, power source 10 may convert heat energy released by the combustion of fuel 5 (a hydrocarbon based fuel) to mechanical energy. The combustion process may also release byproducts, such as exhaust gas 25.

Fuel/air input system 20 may be configured to introduce fuel 5 for combustion into the power source 10. Fuel 5 may be input into power source 10 in a form suitable for efficient combustion. Depending upon the type of power source 10, this suitable form may include a mixture of fuel 5 and air. In some applications, fuel 5 and air may be input separately into power source 10. Fuel/air input system 20 may include valves, compressors, carburetors, injectors, pumps, ducting and other components known in the art.

Exhaust system 30 may direct exhaust gas 25 out of power source 10. Exhaust gas 25 may comprise many chemical species including, among others, NOₓ, which may be regulated by government agencies. NOₓ in exhaust gas 25 includes a mixture of nitrogen dioxide (NO₂) and nitrogen oxide (NO). Exhaust system 30 may include components and systems designed to reduce the amount of adverse chemical species in the exhaust gas 25 prior to being released to the environment. These components and systems may include, among others, a particulate filter 32 and an SCR system 34. Particulate filter 32 may extract solid particulate matter from the exhaust gas 25, and SCR system 34 may reduce or eliminate the NOₓ present in the exhaust gas 25. Exhaust system 30 may also include additional filtration and catalytic conversion devices designed to further reduce the amount of chemical species in exhaust gas 25.

Particulate filter 32 may include any filter used in the art to remove particulate matter from the exhaust stream of an engine. In some embodiments, particulate filter 32 may include a flow-through or a wall-flow filter media made of ceramic honeycomb or metal fiber material. Particulate matter contained in exhaust gas 25 may be collected on the filter media while the exhaust gas 25 flows through particulate filter 32. Particulate filter 32 may require periodic regeneration. Regeneration is the process of removing the accumulated particulate matter from the filter media by burning it off. The particulate filter 32 may be regenerated when a temperature of the particulate matter trapped in the particulate filter 32 reaches an ignition temperature. Regeneration of the particulate filter 32 may be carried out passively or actively. In embodiments where passive regeneration is employed, the filter media may include catalysts to lower an oxidation temperature of the trapped particulate matter. In embodiments where active regeneration is employed, the particulate filter 32 may be associated with heaters to heat the filter media to the oxidation temperature of the trapped particulate matter.

SCR system 34 may include any catalytic converter known in the art to reduce NOₓ to nitrogen and water. SCR system 34 may include a porous substrate with a washcoat to support a catalyst. In some applications, this porous substrate may include a ceramic honeycomb or various metal type substrates. The washcoat may form a rough irregular surface on the porous substrate and may increase the surface area of the substrate. The catalyst may be coated on the surface of the substrate. In some embodiments, the catalyst may be added as a suspension in the washcoat before application to the substrate. The catalyst may include a metal or a metal oxide. In some embodiments, the catalyst may include a precious metal, such as platinum, palladium or rhodium. Exhaust gas 25 may be mixed with a reductant, such as, for example, H₂ 75 and then passed through the SCR system 34. While in the SCR system 34, chemical reactions may reduce some or all of the NOₓ present in exhaust gas 25 to N₂ and H₂O. The catalyst of the SCR system 34 may affect the rate of these reactions. The current disclosure can be used with any known SCR substrate and catalyst.

Hydrogen generator 100 may produce the reductant H₂ 75, which is mixed with the exhaust. In some embodiments, hydrogen generator 100 may produce a mixture of H₂ 75 in combination with other liquids or gases. In these embodiments, a gas separator 110 may separate the H₂ 75 from the mixture. H₂ 75 produced by hydrogen generator 100 may be input to engine system 400 at multiple locations. In some embodiments, H₂ 75 may be input to both fuel/air input system 20 and exhaust system 30. It is contemplated that, in some embodiments, H₂ 75 may be input into only one of these systems. In embodiments where H₂ 75 is directed into fuel/air input system 20, an inlet duct 120 may direct the H₂ 75 into the fuel 5 upstream of engine 10. It is contemplated that, in some embodiments, the H₂ 75 may alternatively or additionally be directed into an air supply prior to mixing with fuel 5. It is also contemplated that, in some embodiments, H₂ 75 may be input directly into a combustion chamber of power source 10. In embodiments where H₂ 75 is directed into exhaust system 30, an inlet duct 130 may direct the H₂ 75 into exhaust gas 25 at a location downstream of engine 10. In some embodiments, H₂ 75 may be input into the exhaust downstream of particulate filter 32.

Hydrogen generator 100 may produce H₂ 75 on-board machine 500. For instance, hydrogen generator 100 may be configured to produce H₂ 75 by electrolysis of an electrolyte. Electrolysis is a method of separating bonded elements and/or compounds in an electrolyte by passing an electric current through the electrolyte. In some embodiments, water may be used as the electrolyte. In these embodiments, electrolysis of water decomposes water into oxygen and hydrogen gas with the aid of an electric current. It is also contemplated that an acid or a base material mixed with water may serve as the electrolyte. In some embodiments, hydrogen generator 100 may produce a mixture of H₂ 75 and other gases. In these embodiments, gas separator 110 may separate H₂ 75 from the mixture of gases.

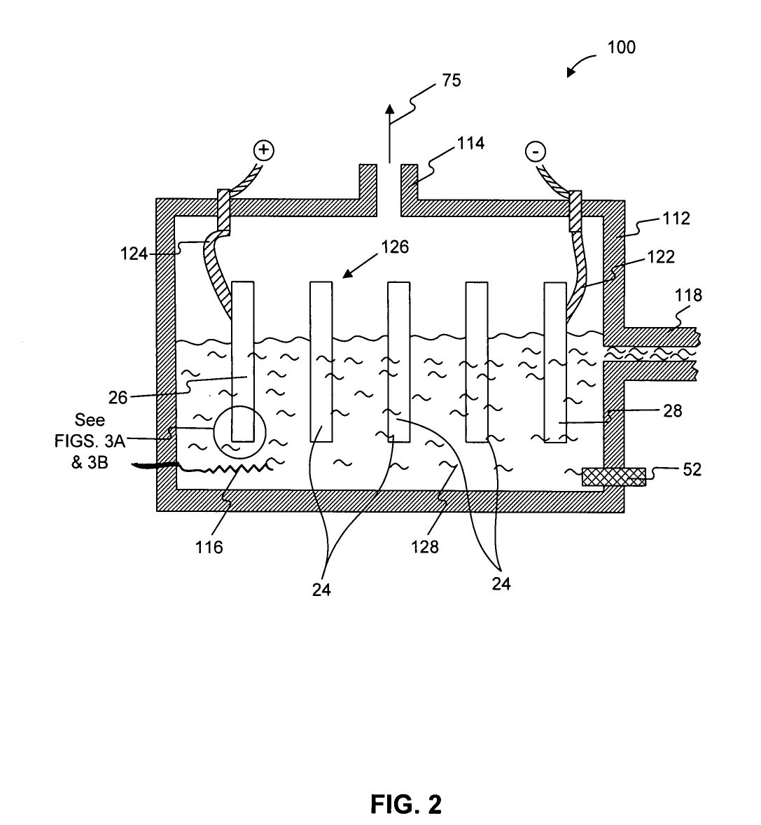

FIG. 2 illustrates an exemplary hydrogen generator 100 that may be located on-board machine 500 and used in conjunction with engine system 400. Hydrogen generator 100 may be disposed at any location relative to engine system 400. In some applications, hydrogen generator 100 may be mounted on engine system 400. It is also contemplated that in some applications, hydrogen generator 100 may be formed integral with engine system 400. Hydrogen generator 100 may include a housing 112. Housing 112 may be made of any material that can safely contain an electrolyte 128, and can withstand temperatures produced during electrolysis of electrolyte 128. Although housing 112 of a rectangular shape is depicted in FIG. 2, housing 112 may be of any shape. Housing 112 may be of unitary construction, or may include multiple parts (for instance, a body and a lid) attached together.

Housing 112 may also include ports that provide access to the inside thereof. These access ports may include, among others, a gas port 114 and an electrolyte port 118. Gas port 114 may serve as an outlet for the gas produced within hydrogen generator 100. Electrolyte port 118 may serve as a conduit for replenishment of electrolyte 128. Although only one gas port 114 and one electrolyte port 118 are depicted in FIG. 2, it is contemplated that other embodiments may include multiple gas ports 114 and/or multiple electrolyte ports 118. Multiple electrodes 126 may also be included within housing 112. A portion of these electrodes 126 may be at least partially immersed in electrolyte 128.

Electrodes 126 may include an anode electrode 28, and a cathode electrode 26. The electrodes 126 may also include one or more secondary electrodes 24 interposed between anode electrode 28 and cathode electrode 26. In some embodiments, some or all of the secondary electrodes 24 may be electrically connected to each other. Different connection schemes may be used to connect the electrodes. For example, in some embodiments, half of all the secondary electrodes 24 may be connected to the cathode electrode 26, while the other half of secondary electrodes 24 may be connected to the anode electrode 28. In some embodiments, the electrodes 126 may have a fixed spatial relationship to each other. In these embodiments, it is contemplated that housing 112 may include some mechanism to maintain the fixed spatial relationship between electrodes 126. In some embodiments, spacing between adjacent electrodes 126 may be substantially constant. Electrical cables may connect anode and cathode electrodes 28, 26 to poles of a power source (not shown). In some embodiments, an anode cable 122 may electrically connect anode electrode 28 to the negative pole of the power source, and a cathode cable 124 may electrically connect cathode electrode 124 to the positive pole of the power source. In some embodiments, electrical cables 122 and 124 may connect anode electrode 28 and cathode electrode 26 to different connection points on the external surface of housing 112. In these embodiments, additional electrical cables may connect these connection points to appropriate poles of the power source. The power source may be a battery of machine 500 used to crank engine 400 and power other components of machine 500.

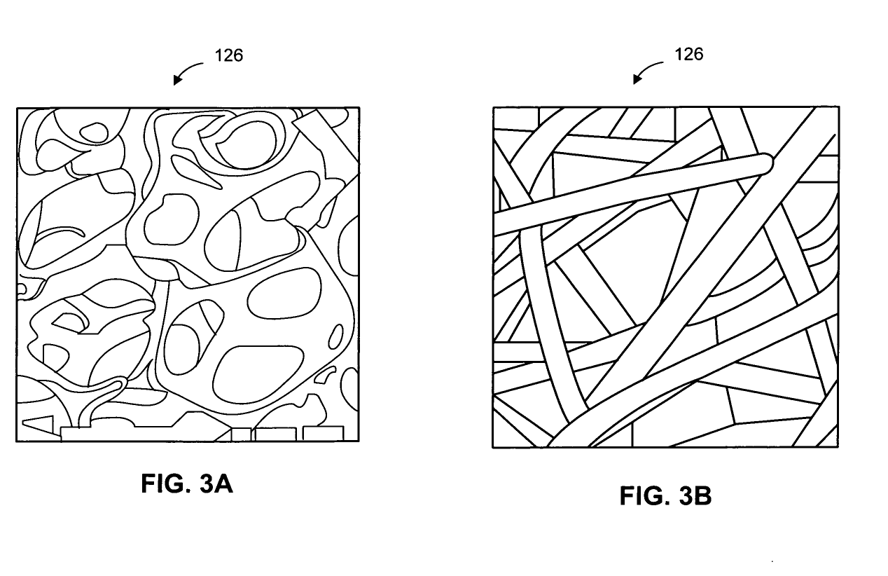

Electrodes 126 may be made of any electrically conductive material. In some embodiments, electrodes 126 may be made of a base metal. Non-limiting examples of materials that may be used as electrodes 126 include iron, aluminum, chromium, nickel, tin, and lead. In general, electrodes 126 may have a solid or a porous structure. FIGS. 3A and 3B show two embodiments of an electrode having a porous structure. The electrode surface area in contact with the electrolyte 128 may be higher for electrodes 126 having a porous structure. Consequently, gas production with electrodes 126 having a porous structure may also be higher. Electrodes 126 having a porous structure may include open cell foams, high porosity sintered metal fibers, metal mesh and the like.

Any electrolyte 128 may be used with hydrogen generator 100. In some embodiments, electrolyte 128 may include water. However, other electrolytes such as acidic solutions, aqueous bicarbonate solutions, hydroxide solutions, or mixtures thereof are also contemplated. As mentioned earlier, when a voltage is applied to anode electrode 28 and cathode electrode 26, electrolyte 128 may decompose to produce H₂. In embodiments where electrolyte 128 is water (pure or mixed with other electrolytes), the electrolyte 128 may decompose according to Eq. 1 below:

2H₂O→2H₂+O₂ Eq. 1

The resulting H₂ and O₂ mixture may exit the hydrogen generator 100 through gas port 114, and H₂ may be separated from the mixture by gas separator 110. Energy may also be released during the decomposition process. The released energy may increase the temperature of hydrogen generator 100.

Electrolyte 128 may be consumed during operation of hydrogen generator 100. The consumed electrolyte 128 may be replenished through the electrolyte port 118. Although not shown in FIG. 2, hydrogen generator 100 may include sensors and alarms to detect a low amount of electrolyte 128, and warn an operator when the electrolyte level drops below a preset value. Hydrogen generator 100 may also include valves and other safety features for the safe operation of hydrogen generator 100. These safety features may include gas release valves and pressure indicators that maintain the pressure within housing 112 within acceptable limits.

As described above, decomposition of electrolyte 128 by electrolysis may produce hydrogen gas as a mixture of gases. H₂ 75 may then be separated from this gaseous mixture in gas separator 110 prior to mixing with fuel 5 or exhaust gas 25. In some applications, it may be desirable to eliminate gas separator 110 and produce substantially only hydrogen gas in hydrogen generator 100. In these embodiments, an electrochemical reaction may be used to produce H₂ 75 as substantially the only reaction product, and the H₂ 75 may be directly mixed with fuel 5 and/or exhaust gases 25. An electrochemical reaction is a chemical reaction between the electrodes and the electrolyte when an electric current passes through them. The electrochemical reaction in such an embodiment may proceed as indicated in Eq. 2 below:

2M+2H₂O+2OH⁻→2M(OH)₂+H₂+2e⁻ Eq. 2

Any metal (M) can be used as electrodes 126. However, since electrodes 126 may be consumed in the electrochemical reaction, they may need more frequent replacement, as compared to a hydrogen generator 100 producing H₂ 75 by electrolysis of electrolyte 128. Therefore, in the electrochemical embodiments, low cost and easy availability of the electrode material may be important factors in the selection of electrodes 126.

An elevated temperature may increase the rate of the electrolysis reaction. Therefore, a heater 116 may be provided in hydrogen generator 100 to vary the rate of H₂ 75 production. In some embodiments, heater 116 may be an external heater. In some embodiments, operation of heater 116 may be controlled to vary the rate of H₂ 75 production depending upon the need for NOₓ reduction by machine 500.

An electronic control module (ECM) 50 (shown in FIG. 1) may be used to control the rate of H₂ 75 production based on the needs of machine 500. In some embodiments, ECM 50 may be part of a larger control system of machine 500. ECM 50 may be any control device that affects the operation of exhaust system 30 based on inputs from multiple sensors. These sensors may include, among others, an upstream NOₓ sensor 54, a downstream NOₓ sensor 56, a hydrogen sensor 58, and a temperature sensor 52.

Upstream NOₓ sensor 54 may be connected on the upstream side of SCR system 34, and may measure the quantity of NOₓ present in exhaust gases 25 upstream of SCR system 34. Downstream NOₓ sensor 56 may be connected on the downstream side of SCR system 34, and may measure the quantity of NOₓ present in exhaust gases 25 downstream of SCR system 34. Using measurements from upstream NOₓ sensor 54 and downstream NOₓ sensor 56, ECM 50 may determine the NOₓ conversion efficiency of SCR system 34.

Hydrogen sensor 58 may measure H₂ 75 flow from hydrogen generator 100 into the exhaust stream. Hydrogen sensor 58 may be a flow meter or other kind of measurement device that is capable of measuring the quantity of H₂ 75 flowing through inlet duct 130. Some embodiments may also include measurement devices that measure the concentration of hydrogen gas emanating from hydrogen generator 100 and gas separator 110.

Temperature sensor 52 may include any type of sensor that measures a temperature of hydrogen generator 100. Although FIG. 2 depicts the temperature sensor 52 as being positioned to measure a temperature of electrolyte 128, temperature sensor 52 can alternatively be positioned to measure a temperature anywhere within hydrogen generator 100.

ECM 50 may perform numerous control functions to increase the efficiency and promote safe operation of the hydrogen generator 100 and exhaust system 400. Non-limiting examples of some of the control tasks that may be performed by ECM 50 include: decreasing H₂ production in hydrogen generator 100 when NOₓ content in exhaust gas 25 is low, shutting down hydrogen generator 100 when temperature sensor 52 indicates an excessive temperature or when other sensors in hydrogen generator 100 indicate an abnormal condition, warning a machine operator at the occurrence of an event, etc.

In some embodiments, ECM 50 may control the electric current to heater 116 (FIG. 2) or electric current to cathode electrode 26 and anode electrode 28 to regulate the amount of H₂ 75 produced based on the NOₓ conversion efficiency. For instance, if NOₓ sensor 56 indicates an excessive concentration of NOₓ, H₂ 75 production in hydrogen generator 100 may be increased. ECM 50 may also control H₂ production based on a desired ratio of H₂:NOₓ. The rate of NOₓ reduction in SCR system 34 may be affected by the relative concentrations of NOₓ and H₂. Typically, a 1:1 molar ratio of NO to H₂ will enable efficient reduction of NO, and a 1:2 molar ratio of NO₂ to H₂ will enable efficient reduction of NO₂. Typically, a H₂:NOₓ ratio between about 1 and about 3 may enable efficient NOₓ removal from exhaust gas 25.

In some embodiments, a portion of the H₂ 75 produced by hydrogen generator 100 may be input into fuel/air input system 20. The hydrogen enhanced fuel 5 may result in increased engine efficiency and/or less NOₓ in exhaust gas 25. In some cases, H₂ 75 produced in excess of what is needed to reduce NOₓ in SCR system 34 may be diverted to the fuel/air system 20. In some embodiments, excess H₂ 75 may be stored in a hydrogen storage vessel 115. This stored H₂ 75 may then be used to respond to rapid increases in H₂ demand and/or extended or excessive H₂ demands.

### INDUSTRIAL APPLICABILITY

The disclosed hydrogen generator may be applicable to any engine system where NOₓ reduction is desired. The hydrogen gas chemically reduces NOₓ to nitrogen and water. To illustrate the operation of the hydrogen generator, an exemplary application will now be described.

During operation of machine 500, exhaust gas 25 containing NOₓ may be released into exhaust system 30 by engine system 400. In exhaust system 30, exhaust gas 25 may flow sequentially through particulate filter 32 and SCR system 34. Particulate matter contained in exhaust gas 25 may be filtered out by particulate filter 32, so that exhaust gas 25 down stream of particulate filter 32 may contain less particulate matter than exhaust gas 25 upstream of particulate filter 32. NOₓ sensor 54 may measure the NOₓ content in exhaust gas 25 upstream of SCR system 34. In response to the measured amount of NOₓ in exhaust gas 25, ECM 50 may instruct hydrogen generator 100 to produce a corresponding amount of H₂. Instructing hydrogen generator 100 may include passing electric current from a battery through cathode electrode 26 and anode electrode 28, and/or by controlling heater 116 to increase the temperature of electrolyte 128.

Hydrogen generator 100 may produce H₂ 75 by an electrochemical reaction. Iron (Fe) electrodes 126 may be partially immersed in electrolyte 128 made of potassium hydroxide solution (KOH+H₂O) contained within the hydrogen generator 100. ECM 50 may control hydrogen generator 100 to produce H₂ 75 to achieve a H₂:NOₓ ratio in exhaust gas 25 of about 2. Hydrogen generator 100 may produce H₂ 75 according to the electrochemical reaction of Eq. 3 below:

Fe⁰+KOH+2H₂O→Fe(OH)₃+K⁺+H₂+e⁻ Eq. 3

H₂ 75 produced by the electrochemical reaction may be input into exhaust system 30 through inlet duct 130. H₂ 75 may mix with exhaust gas 25 before entering the SCR system 34. The NOₓ components of exhaust gas 25 may react with the mixed H₂ 75 in the presence of the catalyst of SCR system 34 in accordance with the chemical reactions of Eq. 4 and Eq. 5 below. These reactions may substantially reduce the NOₓ content in the exhaust gas 25 released into the atmosphere.

2NO+2H₂→N₂+2H₂O Eq. 4

2NO₂+4H₂→N₂+4H₂O Eq. 5

In the hydrogen generator 100 of the current disclosure, H₂ 75, which is used as the reductant in SCR system 34, may be produced on-board machine 500. On-board production of the reductant may eliminate the need for a distribution network to support the use of the technology. In embodiments of hydrogen generator 100, where H₂ 75 is produced by an electrochemical reaction, the consumable electrodes 126 may need to be supplied to hydrogen generator 100 periodically. However, in these embodiments, selection of a commonly available material as electrodes 126 may minimize the need for a dedicated distribution network.

Since the reactions within hydrogen generator 100 of the current disclosure produce only non-toxic gases, dangers associated with the release of these gases to the atmosphere may be minimized. In embodiments of the hydrogen generator 100 producing H₂ 75 by an electrochemical reaction, gas separation systems may also be unnecessary, thereby decreasing the cost of the hydrogen generator 100. In addition, since water or another non-fuel electrolyte is used to produce H₂ 75, the fuel efficiency (and thus the operating cost) of machine 500 may be minimally affected.

It will be apparent to those skilled in the art that various modifications and variations can be made to the disclosed on-board hydrogen generator. Other embodiments will be apparent to those skilled in the art from consideration of the specification and practice of the disclosed hydrogen generator. It is intended that the specification and examples be considered as exemplary only, with a true scope being indicated by the following claims and their equivalents.

What is claimed is:

1. A hydrogen generator for use with an engine, comprising:
an exhaust duct situated to receive exhaust from the engine;
an SCR device located within the exhaust duct;
a housing in fluid communication with the exhaust duct upstream of the SCR device;
an electrolyte solution disposed within the housing;
a plurality of electrodes at least partially submerged in the electrolyte solution and being electrically powered to produce hydrogen gas, the hydrogen gas being directed to mix with the exhaust.

2. The hydrogen generator of claim 1, wherein the hydrogen gas is produced as a mixture of hydrogen and oxygen by electrolysis of the electrolyte.

3. The hydrogen generator of claim 1, wherein the hydrogen gas is substantially the only gaseous reaction product of an electrochemical reaction between the electrodes and the electrolyte.

4. The hydrogen generator of claim 1, wherein the plurality of electrodes are made of a porous material.

5. The hydrogen generator of claim 1, wherein the porous material includes one of an open cell foam, a high porosity sintered metal fiber, and a metal mesh.

6. The hydrogen generator of claim 1, wherein the electrolyte includes one of water, an acidic solution, an aqueous bicarbonate solution, and a hydroxide solution.

7. The hydrogen generator of claim 1, further including a passageway fluidly connecting the housing to an inlet of the engine to mix the produced hydrogen gas with at least one of fuel and air entering the engine.

8. The hydrogen generator of claim 7, wherein hydrogen gas in excess of what is needed to reduce the concentration of the exhaust constituent is directed to the inlet of the engine.

9. The hydrogen generator of claim 1, further including a gas separator configured to separate the hydrogen gas from a mixture of gases.

10. The hydrogen generator of claim 1, further including a heater configured to heat the electrolyte to increase production of the hydrogen gas.

11. The hydrogen generator or claim 1, further including a storage vessel to store a portion of the hydrogen gas produced by the hydrogen generator, the stored portion of hydrogen gas being directed to mix with the exhaust during periods of increased hydrogen demand.

12. The hydrogen generator of claim 1, further including a control system, the control system configured to regulate hydrogen production based on a measured concentration of the exhaust constituent.

13. A method of reducing NOₓ contained in exhaust gas of an engine, comprising:
passing electric current through electrodes immersed in an electrolyte to produce hydrogen gas;
mixing the hydrogen gas with the exhaust gas of the engine; and
catalyzing the hydrogen/exhaust gas mixture to reduce the NOₓ in the exhaust gas.

14. The method of claim 13, wherein producing hydrogen gas includes producing hydrogen gas by one of an electrolysis of the electrolyte and an electrochemical reaction between the electrodes and the electrolyte.

15. The method of claim 13, wherein producing hydrogen gas further includes regulating production of hydrogen gas based on a measured NOₓ concentration in the exhaust gas.

16. The method of claim 13, further including storing a portion of the produced hydrogen gas, and directing the stored portion of the produced hydrogen gas to the exhaust flow during periods of increased hydrogen demand.

17. The method of claim 13, further including mixing the hydrogen gas with at least one of fuel and air entering the engine.

18. A machine, comprising:
an engine configured to combust a fuel/air mixture to produce exhaust gas containing NOₓ;
a fuel delivery system configured to direct fuel into the engine;
a battery configured to crank the engine;
a housing containing a supply of electrolyte;
a plurality of electrodes at least partially submerged in the electrolyte and powered by the battery to produce hydrogen gas; and
an SCR device situated to receive a mixture of the hydrogen gas and the exhaust gas, and reduce at least a portion of the NOₓ to nitrogen and water.

19. The machine of claim 18, wherein the hydrogen gas is produced by at least one of an electrolysis of the electrolyte and an electrochemical reaction between the electrodes and the electrolyte.

20. The machine of claim 18, wherein the production of the hydrogen gas is regulated based on a concentration of NOₓ in the exhaust gas.
